(19) United States
(12) Patent Application Publication
(10) Pub. No.: US 2011/0187551 A1
(43) Pub. Date: Aug. 4, 2011

(54) ILLUMINATED DOOR BELL

(76) Inventor: Pasquale ARROTTA, Calgary (CA)

(21) Appl. No.: 12/850,695

(22) Filed: Aug. 5, 2010

Related U.S. Application Data
(60) Provisional application No. 61/231,373, filed on Aug. 5, 2009.

(51) Int. Cl. G08B 5/00

(52) U.S. Cl. 340/815.45; 340/815.4

(57) ABSTRACT

The present invention relates to a doorbell comprising: a pushbutton illuminated by a first light source; and a front cover illuminated by a second light source. The first light source and second light source may be positioned within a main body of a doorbell in a manner that ensures that the first light source and the second light source do not mix.

This application claims the benefit of U.S. Provisional Patent Application Ser. No. 61/231,373 filed Aug. 5, 2009.

### FIELD OF THE INVENTION

The present invention relates in general to the field of doorbells, and more particularly to an illuminated doorbell.

### BACKGROUND OF THE INVENTION

Traditional illuminated doorbell pushbuttons include only a single light source that is fixed in place within the doorbell main body. The single light source is used only to illuminate the pushbutton of the doorbell. In the traditional illuminated doorbells a translucent pushbutton with a low voltage miniature bulb is placed across the two button contacts.

U.S. Patent Application No. 2006/0219541, as filed by Birdwell et al. (“Birdwell”), discloses a doorbell that has two light sources. A first light source illuminates the push button. A second light source may illuminate a target area outside the main body of the doorbell through an aperture on the side of the main body of the doorbell. The second light source may be a user-adjustable rotating task light, whereby a reflector is rotated through an arc to direct light to the area desired by the user, such as to a dark step or a door lock.

### SUMMARY OF THE INVENTION

In one aspect, the present disclosure relates to an illuminated doorbell comprising: a main body that includes a front cover and a rear cover attached to the front cover; a pushbutton being attached to the front cover; a first light source positioned to illuminate the pushbutton; and a second light source positioned to illuminate the front cover; and wherein the first light source and the second light source are positioned so as to illuminate the doorbell in a manner whereby the first light source and the second light source do not mix.

In another aspect, the present disclosure relates to a doorbell comprising: a main body including a front cover having an aperture therein; a doorbell pushbutton assembly disposed within the aperture; a first light source capable of emitting light of a first colour, said first light source being disposed within the main body to provide illumination to the pushbutton assembly; and a second light source capable of emitting light of a second colour, said second light source being disposed within the main body to provide illumination to the whole front cover; and whereby the pushbutton assembly of the doorbell is illuminated by the first colour and the front cover of the doorbell is illuminated by the second colour.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates a perspective view of a doorbell according to one aspect of the present invention.

FIG. 2 illustrates an exploded view of a doorbell according to one aspect of the present invention.

FIG. 3 illustrates a printed circuit board for a doorbell according to one aspect of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention is an illuminated doorbell. In one embodiment the present invention may be an illuminated doorbell comprising a fully illuminated pushbutton. The present invention may provide for an illuminated doorbell comprising: a pushbutton illuminated with a first source of light; and a front cover illuminated with a second source of light. The present invention may be so configured that the first source of light and the second source of light do not mix.

In one embodiment of the present invention the illuminated doorbell may be illuminated with a first color and a fully illuminated front cover illuminated with a second color.

The present invention may offer certain benefits over existing prior art in that traditional illuminated doorbell pushbuttons generally only include a single source of illumination of the doorbell. The present invention provides another source of illumination that illuminates the front cover of the main body the doorbell. For example, the Birdwell patent described above, does not disclose an illuminated front cover of the doorbell. Birdwell does not disclose a doorbell wherein two or more sources of light are used to illuminate the pushbutton and two or more sources of light are sued to illuminate the front cover of the doorbell. The present invention may provide a doorbell with an illuminated doorbell pushbutton illuminated with a first color and an illuminated doorbell front cover of the main body illuminated with a second color.

Additional benefits of the present invention over the prior art include that the prior art illuminated doorbells have illuminated parts, and the whole of the doorbell is not lit. The present invention may produce a doorbell that is completely lit. A related benefit of the doorbell of the present invention being fully lit is that the doorbell can be clearly seen at night. Prior art doorbells having portions lit are not as clearly visible.

Yet another benefit of the present invention over the prior art involves the ability of the present invention to illuminate portions of the doorbell with different colours. Prior art doorbells may include parts that are illuminated with a single colour. The present invention may produce a doorbell that has a doorbell body that is fully lit with one color and a pushbutton that is lit with another color. It may be easy for a user to distinguish the pushbutton portion of the doorbell from other portions of the doorbell. This can increase the ease whereby a user may utilize the doorbell.

This is particularly true in low light when specific portions of traditional illuminated doorbells may be difficult to distinguish, such as the pushbutton. The present invention may light the pushbutton with a specific colour that is different than the colour utilized to light other portions of the doorbell, and the pushbutton may be easily distinguishable from other portions of the doorbell due to the colour that the pushbutton is lit with.

Still another benefit of the present invention over the prior art involves the scope of the light source of utilized. Traditional illuminated doorbells may utilize a single light source that is comprised of one or two light units. An embodiment of the present invention may produce a doorbell that includes a PCB adapted to light up at least 8 LED units. This configuration of an embodiment of the present invention may achieve a more effective illumination of the doorbell than is provided by known prior art illuminated doorbells.

Another benefit of the present invention over the prior art, is that the present invention may produce a doorbell that has the entire surface of the doorbell's main body lit. Prior art doorbells do not have the entire surface of the doorbell's main body lit, but rather only portions of the main body are lit. An embodiment of the present invention achieves a doorbell that uses LED to transmit light throughout the fiber transmitting properties of the acrylic fiber, and thereby lights up the entire surface area of the doorbell's main body. This increases the visibility of the doorbell's main body.

The present invention will be explained in details by referring to the figures.

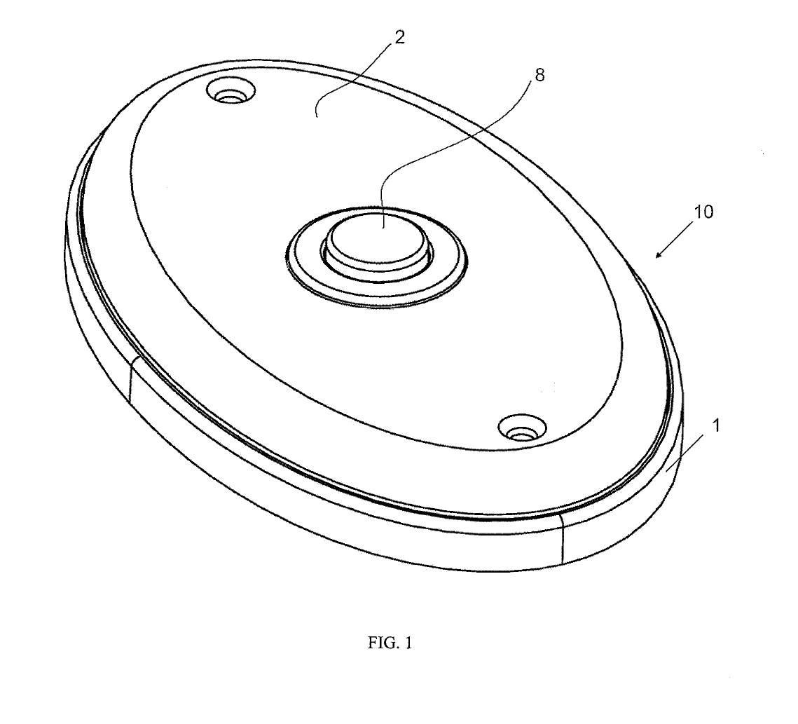

As shown in FIG. 1, a doorbell 10 of the present invention may comprise a front cover 2, a doorbell pushbutton 8, and a rear cover 1. The doorbell may be attached to a location near to a door, such as upon the doorframe. For example, an attachment means may be utilized to attach the doorbell to a surface, in a fixed or removeable manner, and said attachment means may be attachable to the rear cover of the doorbell. A skilled reader will recognize that other means of attaching a doorbell to a surface or location near to a door may be utilized.

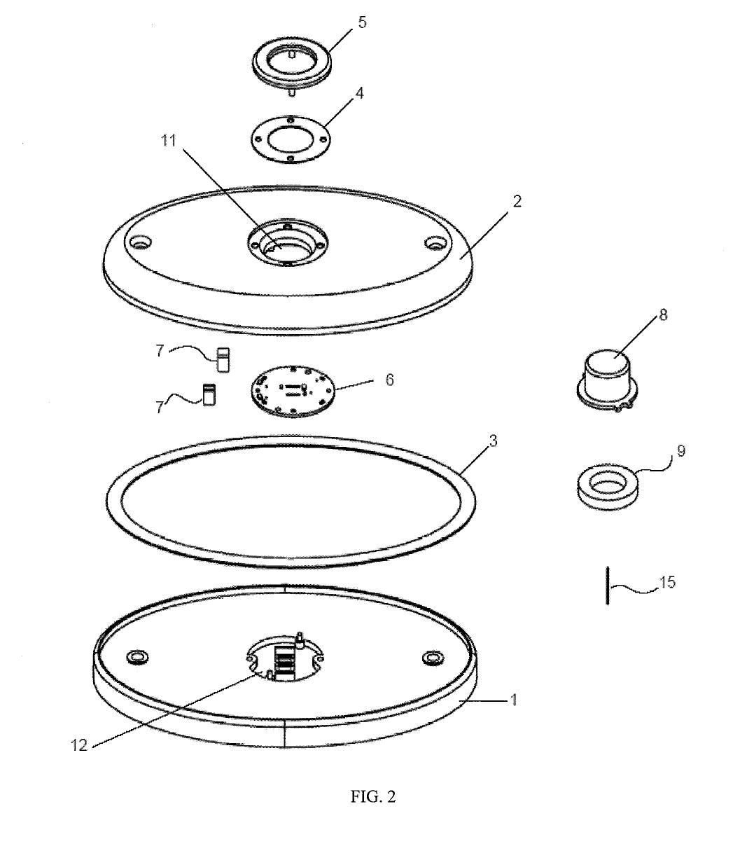

As shown in FIG. 2 in the present invention, the main body of the doorbell 10 may comprise a front cover 2 and a rear cover 1. Front cover 2 may include an aperture 11 sized to receive the pushbutton assembly 8. The pushbutton 8 may be part of a pushbutton assembly comprising the pushbutton 8, a button seal 4, a button ring 5 which may be used to couple the button 8 to the front cover 2, and a button contact 15. Rear cover 1 may include a well 12 to receive a printed circuit board (“PCB”) assembly 6. An adhesive 3 may be included to securely adhere the front cover 2 to the rear cover 1, however, other means of attaching the front cover 2 to the rear cover 1 known in the art may be used.

PCB assembly 6 may be placed in the rear cover 1 by heat stake PCB assembly 6 to the well 12. PCB contacts 7 are installed through PCB 6 into the well 12.

In one embodiment of the present invention, the PCB assembly 6 may comprise a top side facing the top cover 2 and the pushbutton assembly 8 and a bottom side facing the rear cover 1. The top side may accommodate the first source of light for illumination of the pushbutton assembly 8 only, and the second light source for illumination of the entire doorbell main body only. The first source of light may be placed within an area 13 in the center of the PCB assembly 6 such that when the PCB assembly 6 is placed within the main body, the first source of light for the pushbutton is aligned with the aperture in the front cover 2. The second source of light for illumination of the whole doorbell front cover 2 may be included in the periphery of the PCB assembly 6, such that the second source of light for the whole front cover 2 is not exposed by the aperture in the front cover 2. The light emitted by the first and the second sources of light may not mix. The first source of light and the second source of light may be separated by a flexible button membrane 9 used for the spring action of the pushbutton 8 to retract to its normal position. Membrane 9 may effectively separate the light emitted by the first source of light from the light emitted by the second source of light.

The bottom side of the PCB assembly 6 may include regulators, biasing resistors and capacitors which are placed to meet the various voltage and heat distribution input to the unit of the invention.

In one embodiment of the present invention, the first and the second sources of light may be light emitting diodes (LED).

In another embodiment of the present invention, the doorbell assembly may be configured so that a plurality of coloured LED light sources may be utilized to achieve illumination of portions of the doorbell by at least two different LED colors. One colour may illuminate the pushbutton 8 of the doorbell and a second colour may illuminate the front cover 2 of the doorbell. The configuration of the doorbell may be such that the two colors do not mix. A skilled reader will recognize how additional light sources and colours may be applied in the present invention.

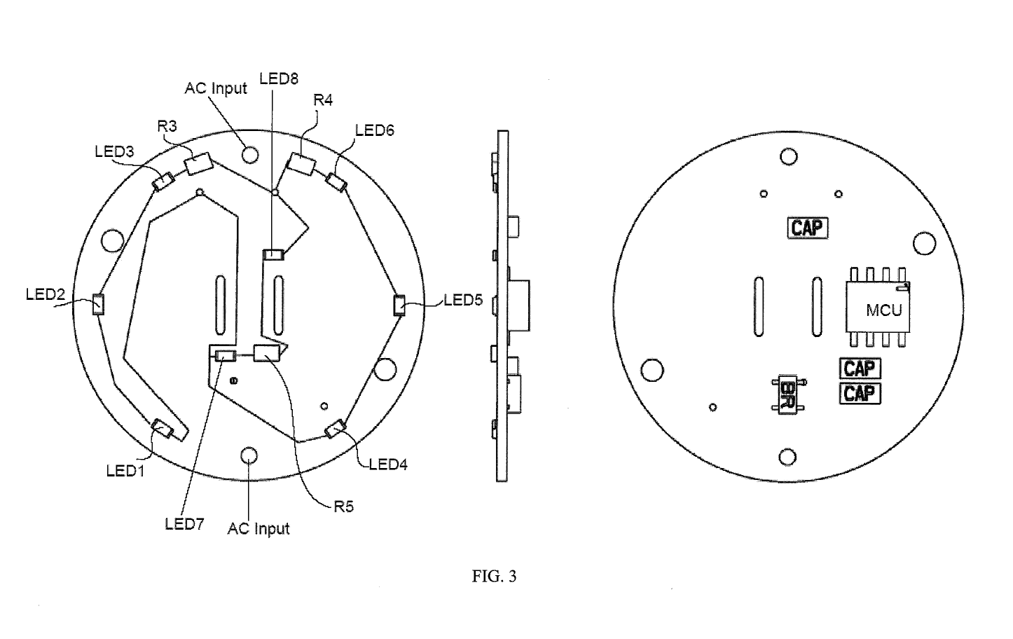

As shown in FIG. 3, in one embodiment of the present invention the top side circuitry 30, may be configured to include a first source of light LED 7, LED 8 capable of emitting light of one color to provide illumination only to a pushbutton. The top side circuitry may also be configured to include a second source of light LED 1, LED 2, LED 3, LED 4, LED 5, LED 6 capable of emitting light of another color to provide illumination only to the whole front cover. A skilled reader will recognize that other configurations of lighting circuitry and general circuitry of may be utilized in the present invention.

In another embodiment of the present invention the first source of light may comprise at least two coloured LEDs LED 7, LED 8. Such colour LEDs, LED 7 and LED 8, may combine to produce a first color. The doorbell may also include a second light source comprising at least 6 coloured LEDS LED 1-LED 6. Such colour LEDs, LED 1-LED 6, may combine to produce a second color.

Doorbells of the prior art traditionally use an iron core transformer of 12 to 24 volts to activate the doorbell plunger, and a voltage exists across the two open circuit push button contacts of the doorbell. In one embodiment of the present invention, as shown in FIG. 2, this voltage may now be applied to an input diode bridge and the regulator circuit on the PCB assembly 6 which now maintains a constant output voltage to the LED's. The brightness of the LED's may be achieved by the resistors limiting the current to a safe level in the entire circuit, while the capacitors filter the AC ripple to a safe level. The current which now travels through the PCB assembly 6 to light up the LED may be less than 0.020 amps, which is not enough to activate the plunger of the doorbell that requires 0.100-0.500 amps to activate the plunger of the doorbell. When the button is pushed by a user to activate the bell, full current flow may be maintained in the circuit across the contacts to activate the plunger, this will cause the LEDs to extinguish momentarily while the button is pressed because there is no current flowing through the PCB assembly 6 at this time.

The front cover and the pushbutton may be made of materials that are clear, transparent or translucent, such that illumination from the first and the second light sources project through the pushbutton and the entire front cover respectively. A skilled reader will recognize that various and unique designed cast acrylic fiber pieces with translucent characteristics may be used to construct the doorbell of the present invention to achieve even light transmission around the entire doorbell.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

It will be appreciated by those skilled in the art that other variations of the embodiments described herein may also be practiced without departing from the scope of the invention. Other modifications are therefore possible. As such modifications or variations are believed to be within the sphere and scope of the invention as defined by the claims appended hereto.

I claim:

1. An illuminated doorbell comprising:
a) a main body that includes a front cover and a rear cover attached to the front cover;
b) a pushbutton being attached to the front cover;
b) a first light source positioned to illuminate the pushbutton; and
b) a second light source positioned to illuminate the front cover; and
wherein the first light source and the second light source are positioned so as to illuminate the doorbell in a manner whereby the first light source and the second light source do not mix.

2. The illuminated doorbell of claim 1, wherein the first light source and the second light source may be different colours and thereby the pushbutton and front cover may be illuminated to appear as different colours.

3. The illuminated doorbell of claim 1, wherein the first light source is comprised of one or more LEDs that combine to produce a first colour.

4. The illuminated doorbell of claim 3, wherein the first light source is comprised of two LEDs.

5. The illuminated doorbell of claim 1, wherein the second light source is comprised of one or more LEDs that combine to produce a second colour.

6. The illuminated doorbell of claim 5, wherein the second light source is comprised of six LEDs.

7. The illuminated doorbell of claim 1, wherein the whole of the pushbutton is illuminated by the first light source,

8. The illuminated doorbell of claim 1, wherein the whole of the front cover is illuminated by the second light source.

9. The illuminated doorbell of claim 1, wherein a printed circuit board including a diode bridge and a regulator circuit capable of maintaining a constant output voltage is utilized to activate the first light source and the second light source.

10. The illuminated doorbell of claim 1, wherein an attachment means may be utilized to attach the rear cover to a surface, whereby the illuminated doorbell may be attached to a surface.

11. The illuminated doorbell of claim 1, wherein the first light source and second light source are positioned within the main body.

12. A doorbell comprising:
a) a main body including a front cover having an aperture therein;
b) a doorbell pushbutton assembly disposed within the aperture;
c) a first light source capable of emitting light of a first colour, said first light source being disposed within the main body to provide illumination to the pushbutton assembly; and
d) a second light source capable of emitting light of a second colour, said second light source being disposed within the main body to provide illumination to the front cover; and
whereby the pushbutton assembly of the doorbell is illuminated by the first colour and the front cover of the doorbell is illuminated by the second colour.

13. The doorbell of claim 12, wherein the first colour and the second colour do not mix.

14. The doorbell of claim 12, wherein the whole of the pushbutton assembly is illuminated by the first light source.

15. The doorbell of claim 12, wherein the whole of the front cover is illuminated by the second light source.

16. The doorbell of claim 12, wherein a printed circuit board including a diode bridge and a regulator circuit capable of maintaining a constant output voltage is utilized to activate the first light source and the second light source.

17. The doorbell of claim 12, wherein the pushbutton assembly comprises:
a) a pushbutton;
b) a button seal;
c) a button ring, whereby the pushbutton is coupled to the front cover; and
d) a button contact.

18. The doorbell of claim 12, wherein the main body includes a rear cover attachable to the front cover.

19. The doorbell of claim 12, wherein a voltage of 12 to 24 volts is applied to an input diode bridge and a regulator circuit that are connected to the first light source and second light source by way of a printed circuit board, whereby a constant output voltage is maintained to the first light source and second light source.

20. The doorbell of claim 19, wherein current flowing through the printed circuit board may be interrupted when the pushbutton is pushed by a user, and the first light source and second light source may be extinguished for the duration of the time when a user pushes the pushbutton.
